(19) United States
(12) Patent Application Publication
(10) Pub. No.: US 2003/0154844 A1
(43) Pub. Date: Aug. 21, 2003

(54) Hands-free chromatic harmonica

(76) Inventor: W. Vernon Smith, Laguna Woods, CA (US)

Correspondence Address: W. VERNON SMITH, 3424 A CALLE AZUL, LAGUNA WOODS, CA, 92653, US

(21) Appl. No.: 10/077,292

(22) Filed: Feb. 19, 2002

(51) Int. Cl. G10D 7/12

(52) U.S. Cl. 84/377

(57) ABSTRACT

Vertical mouthpiece motion replaces the traditional chromatic harmonica's slide valve function and eliminates the valve as a source of air leakage, friction, and sticking. Because the player's mouth pushes a movable mouthpiece between an upper and a lower position with respect to the attached chromatic harmonica, the use of the player's hands is unnecessary. In the upper position, the row of air holes conducts the player's breath through an upper row of reed chambers. In the lower position, the same air holes conduct the player's breath through a lower row of reed chambers.

### CROSS REFERENCES TO RELATED APPLICATIONS

N/A

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

The field of endeavor is the mouth harmonica, US classification 84/377.

The chromatic harmonica player who has lost his hands or hand functions through injury, or who occupies his hands playing another musical instrument, needs a way of playing without using his hands.

When playing a conventional chromatic harmonica, the player's finger presses or releases a button to select between two sets of reeds. The sets usually correspond to the pitches found on the white and black keys of the piano. Pressing or releasing of the button slides a valve plate that directs the player's breath to the desired set of reeds. Various implementations of slide valves in chromatic harmonicas are described in U.S. Pat. Nos. 1,671,309; 1,780,368; 2,608,898; 2,675,727; 2,726,567; 2,815,693; 2,910,633; 3,674,910: and 3,757,025.

The operation of the conventional chromatic harmonica requires the sliding of the valve plate between two mating surfaces. There is a conflict between reduced clearance to minimize air leakage and increased clearance to minimize friction. The flatness and thickness tolerances necessary for good slide valve operation are not always met in production harmonicas. Saliva can congeal in the valve so that the sliding plate cannot be pushed in at all, or it operates with increased friction so that it will not quickly return to its spring-loaded rest position.

Hands-free operation has previously been provided through use of a foot pedal that is linked to the slide valve by pneumatic, hydraulic, electrical, and/or mechanical means. U.S. Pat. No. 4,414,879 describes an example. These linkages tend to be complex, bulky, noisy, slow, and expensive. They often use external power, requiring a large battery or connection to electrical mains.

### BRIEF SUMMARY OF THE INVENTION

The object of the invention is a chromatic harmonica capable of operation without the use of the player's hands. A further object is to avoid the aforementioned disadvantages of foot-pedals and slide valves.

In playing a conventional chromatic harmonica and in playing the invention, the player positions his head and forms his mouth to breathe through a single hole in the mouthpiece, thus selecting the four reeds associated with that hole.

In the conventional chromatic harmonica, the un-pushed or pushed position of the slide valve button directs breath through the upper or lower chamber. However, in the invention, the player moves his mouth a short distance vertically to move the mouthpiece and align the selected hole with the upper or lower reed chamber and its two reeds.

In the invention and in a conventional harmonica, the player blows or draws in his breath to determine which one of the two reeds in the selected chamber sounds.

In playing the conventional chromatic harmonica, the hands are used to actuate the slide valve and to hold the instrument. The invention makes it possible to perform the function of the slide valve without using the hands. To play the instrument without use of the hands also requires a holder to position the harmonica at the player's mouth. A wire holder that rests on the player's shoulders and encircles the back of his neck is inexpensive and commercially available. Such a holder, called a “neck rack,” is commonly used to play a guitar or piano with a diatonic harmonica that does not have a slide valve.

### BRIEF DESCRIPTION OF THE SEVERAL VIEWS OF THE DRAWING

One sheet having three views is included.

FIG. 1 shows the invention from the player's point of view with the movable mouthpiece in the upper position to direct breath through the upper row of reed chambers.

FIG. 2 is the same as FIG. 1 except that the movable mouthpiece is in the lower position.

FIG. 3 shows the section 1-1 indicated in FIG. 1, with the important internal parts not visible from the outside. In particular, it shows how, when the mouthpiece is in the upper position, the air hole aligns to permit airflow through the upper reed chamber with airflow through the lower chamber blocked.

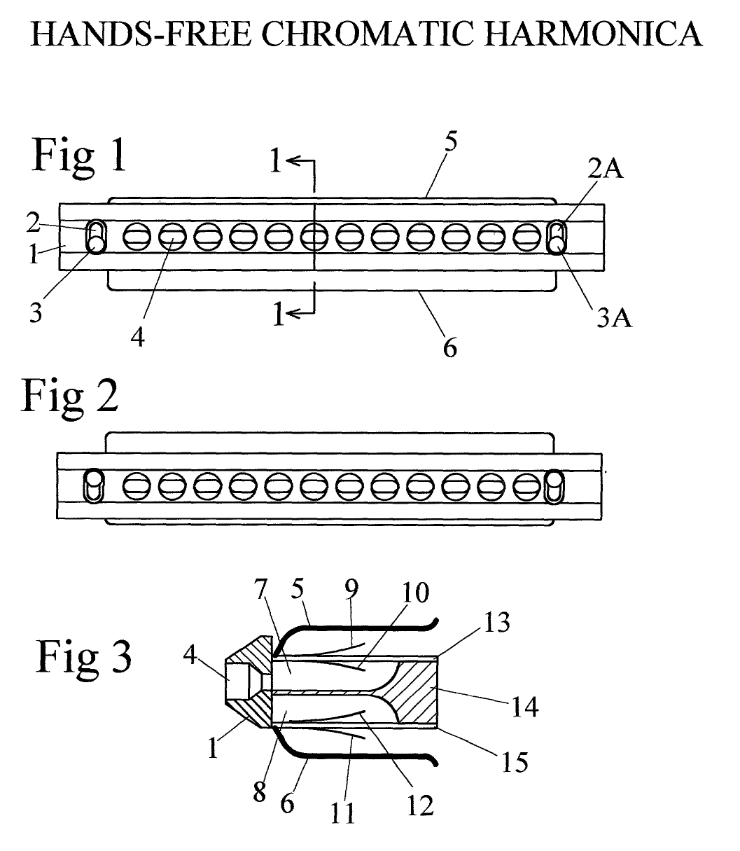

### DETAILED DESCRIPTION OF THE INVENTION

The preferred embodiment of the invention uses all of the parts and functions of a conventional chromatic harmonica 5, 6, 7, 8, 9, 10, 11, 12, 13, 14, 15 less the mouthpiece and slide valve assembly. The parts retained and used include the following:

1. The comb 14 has a multiplicity of chambers 7, 8 that direct air to the reeds 9, 10, 11, 12 and is the core structure to which the other parts are attached. Vertical partitions separate adjacent chambers 7, 8. A horizontal partition separates the upper row 7 from the lower row 8 of chambers. The comb 14 may be of wood, plastic, or metal.

2. Two metal reed plates 13, 15 contain the reeds 9, 10, 11, 12. The reed plates 13, 15 comprise the upper cover of the upper row of reed chambers 7 and the lower cover of the lower row of chambers 8. For each of a multiplicity of chambers 7, 8, the reed plate 13, 15 has one blow reed 10, 12 mounted on the inside surface and one draw reed 9, 11 mounted on the outside surface.

3. Two covers 5, 6 provide mechanical protection for the draw reeds 9, 11 and direct the sound in a way similar to the bell of a trumpet. The covers 5, 6 may be metal, plastic, or wood.

A lightweight plastic mouthpiece 1 has air holes 4 equal in number and spacing to one row of reed chambers 7, 8. The mouthpiece 1 is held loosely captive against the face of the comb 14 by two screws 3, 3A inserted through vertical slots 2, 2A in the mouthpiece 1. When the upper ends of the slots 2, 2A touch the screw 3 shafts, then the air holes 4 are positioned to conduct the player's breath to the lower row of chambers 8 and conversely for the lower slot 2, 2A ends and the upper chambers 7. Using lips, tongue, and side-to-side mouth position, the player directs his breath through a single air hole 4 of the mouthpiece. Then by nodding his head and thus raising or lowering his mouth a small distance, he urges the mouthpiece 1 over either the upper or lower row of reed chambers 7, 8. In this way, vertical mouth motion in the invention performs the same function as motion of the finger-actuated slide valve does in the conventional chromatic harmonica. Finally, by blowing or drawing his breath, he causes a single reed 9, 10, 11, 12 to sound. The mouthpiece 1 is held loosely captive by the screws 2, 2A against the comb 14. When the player moves the mouthpiece 1 between the two playing positions, the pressure of his mouth decreases and a generous clearance between mouthpiece 1 and comb 14 allows easy and friction-free movement. When a note is being sounded, the pressure of his mouth increases, forcing the mouthpiece into contact with the comb 14 and allowing negligible air leakage. This happens without conscious effort on the part of the player.

The removal of screws 3, 3A allows the mouthpiece 1 to quickly and easily come free for cleaning and lubrication. CLAIM

I claim:

1. a chromatic harmonica whose mouthpiece moves vertically with respect to the comb to align a row of mouthpiece air holes with upper and lower rows of reed chambers.

2. a chromatic harmonica according to claim 1 wherein the mouthpiece motion is limited by a cylinder projecting from the comb and protruding through a slot in the mouthpiece.

3. a chromatic harmonica according to claim 2 wherein the movable mouthpiece is held loosely captive against the comb by a head on the cylindrical projection having a diameter larger than the slot width.
